(19) United States
(12) Patent Application Publication
(10) Pub. No.: US 2024/0394167 A1
(43) Pub. Date: Nov. 28, 2024

(54) SYSTEM AND METHODS FOR OPTIMIZED EXECUTION PLANS FOR SERVERLESS DIRECTED ACYCLIC GRAPH WORKFLOWS

(71) Applicants: Sameh Elnikety, Redmond, WA (US); Purdue Research Foundation, West Lafayette, IN (US)

(72) Inventors: Somali Chaterji, West Lafayette, IN (US); Saurabh Bagchi, West Lafayette, IN (US); Ashraf Mahgoub, West Lafayette, IN (US); Sameh Elnikety, Redmond, WA (US)

(73) Assignee: Purdue Research Foundation, West Lafayette, IN (US)

(21) Appl. No.: 18/676,405

(22) Filed: May 28, 2024

Related U.S. Application Data
(60) Provisional application No. 63/469,336, filed on May 26, 2023.
(60) Provisional application No. 63/469,334, filed on May 26, 2023.

(51) Int. Cl. G06F 11/34

(52) U.S. Cl. CPC G06F 11/3409

(57) ABSTRACT

A system may receive a first directed acyclic graphic (DAG) for an application. The system may model performance of each function in the DAG to generate a performance model. The system may generate a plurality of variant DAGs. For each of the variant DAGs, the system may obtain a configuration vector and forecast, based on the performance model and the configuration vector, a plurality of end-to-end latency distributions for the variant DAGS. The system may select the variant DAG and configuration vector based on a selection criteria. The system may cause an application to be executed according to the variant DAG and configuration vector.

### CROSS REFERENCE TO RELATED APPLICATIONS

This application claims the benefit of U.S. Provisional Application No. 63/469,336 filed May 26, 2023 and U.S. Provisional Application No. 63/469,334 filed May 26, 2023, the entireties of which are incorporated by reference herein.

### TECHNICAL FIELD

This disclosure relates to serverless infrastructure and, in particular, to computer resource optimization.

### BACKGROUND

Serverless computing (a.k.a., function as a service (FaaS)) has emerged as an attractive model for running cloud software for both providers and tenants. Recently, serverless environments are becoming increasingly popular for video processing, machine learning, and linear algebra applications. The requirements of these applications can vary from latency strict (e.g., Video Analytics for Amber Alert responders to latency-tolerant but cost-sensitive (e.g., Training ML models).

The workflow of serverless pipelines is usually represented as a directed acyclic graph (DAG) in which nodes represent serverless functions and edges represent data dependencies between them.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a system.

FIG. 2 illustrates examples of a user-defined DAG and an execution plan.

FIG. 3A-B illustrates an example of a serverless DAG of a video analytics application and an execution plan generated by a system.

FIG. 4 illustrates a first example of a flow diagram for a system.

FIG. 5 illustrates an example of functions from a DAG executing on virtual machines with and without bundling.

FIG. 6A-B illustrates a DAG with fusion where shuffling is not possible and building without fusion where shuffling is possible.

FIG. 7 illustrates an example a flow diagram for logic for a system.

FIG. 8 illustrates a second example of a system.

### DETAILED DESCRIPTION

Serverless workflows are becoming increasingly popular for many applications as they are hosted on a scalable infrastructure with fine-grained resource provisioning and billing. A serverless workflow contains two or more serverless functions organized as a DAG (Directed Acyclic Graph). Commercial providers offer orchestration services to facilitate the design and execution of serverless DAGs (e.g., AWS Step Functions, Azure Durable Functions, and Google CloudWorkflows). However, each function in the DAG is executed in a separate VM without making use of the DAG structure or internal data, which leads to significant increases in the end-to-end (E2E) latency and cost.

To understand the challenges of supporting serverless workflows, we study production workloads of serverless DAGs at a major cloud provider. Our analysis shows that the vast majority of DAG executions (94.6%) are for recurring DAGs, with an invocation rate of greater than 1.6K times per day. With this high rate of invocations, the cloud provider can monitor the DAG's execution parameters and quickly identify performance bottlenecks to optimize. We identify two major performance bottlenecks in serverless DAGs: (1) Communication latency between in-series workers, which stems from the intermediate data being handled through remote storage. (2) Computation skew among in-parallel workers, which is caused by different processing times by the parallel workers on different contents. Our analysis of the production DAGs shows that 46% of the DAGs have a high communication latency of 32% or more of the DAG's E2E latency, and 48% of the DAGs have a high computation skew of 2× or more between parallel workers. Both these factors are caused (to varying extents) by the fact that state-of-practice executes each function in the DAG in a separate isolated container (or VM).

The system and methods described herein provide, among other technical advancements, an automated approach to generate an optimized execution plan for serverless DAGs. Users provide the system with a DAG definition including individual functions as nodes, and their data dependencies as edges (as is typical in today's commercial offerings). The system performs at least optimizations including. (1) Fusion: Combining in-series functions together as a single execution unit. (2) Bundling: Executing parallel invocations of the same function together in the same VM. (3) Resource Allocation: Assigning the best VM size, CPU cores, storage capcityk and/or network bandwidth for functions and bundles of functions in the DAG. First, we show that Fusion allows for optimized communication between cascaded functions due to leveraging data locality between sending and receiving functions. Second, we show that Bundling allows for skew mitigation between parallel workers and reduces E2E latency. Finally, assigning the best VM sizes/resource allocations for each bundle is essential to minimize its latency and $ cost.

Selecting a good execution plan for a serverless DAG poses three technical challenges. First, serverless functions experience a high runtime variability, even when executed as standalone functions. This variability in runtime can be either in the function's communication time (i.e., while downloading/uploading data from remote storage), or in processing times. Hence, we need to model the communication time and processing time of individual functions as well as of the entire DAG as distributions, rather than single-point estimates. We also need to estimate the impact of Fusion or Bundling on the E2E latency distribution. Second, the search space of all possible execution plans is massive, due to the large number of possible DAG widths and VM size choices, making exhaustive grid search infeasible and costly. Therefore, we need an efficient searching algorithm for execution plan selection.

To overcome these challenges, the system and methods described herein make at least three technical contributions. First, the system creates a distribution and correlation-aware performance model to capture the variability in performance for each function. The model breaks down the function's runtime into download, processing, and upload components, while taking into account the correlation between in-series and in-parallel workers. By profiling the latency distributions for the three components for each function, we can identify stages that experience high communication latency (i.e., high latencies in intermediate data download/upload) and hence can benefit from Fusion. The system also identify stages with parallel workers that experience latency skew (i.e., long tail operation) in the processing time, and hence can benefit from Bundling. Second, the system determines the optimal bundle size, and coupled to that, the VM computer resources to allocate for the bundle. Again, using the performance model, the system can estimate the impact of joint Fusion and Bundling of functions on the E2E latency and cost. Finally, the system uses the above two contributions to perform searching that performs a joint and global optimization of the combination of Fusion and Bundling actions.

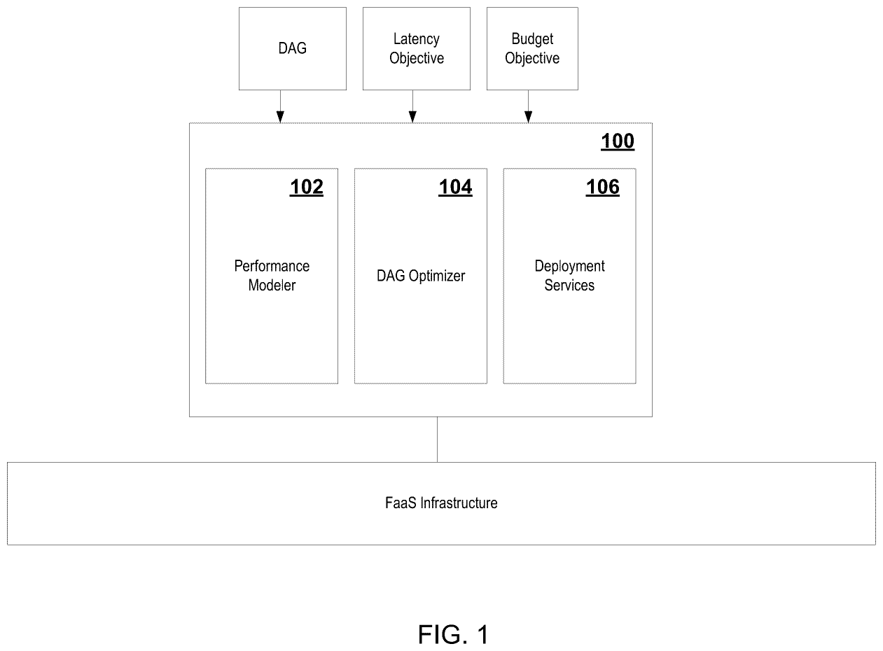

FIG. 1 illustrates an example of the system. The system may include a performance Modeler 102, a DAG optimizer 104, and Deployment Services 106. The user provides the system with a DAG definition, which includes the executable package for each function and the data dependencies between the functions in the DAG.

Then performance modeler evaluates each function as a composition of three steps: download (input data), process, and upload (output data). The modeler then perform per-function profiling and latency modeling to capture the variability in each of these three steps. This is an important step to estimate the gains of fusing in-series functions together in a single VM, or Bundling in-parallel functions together in the same VM. For example, functions that have a high latency in the download or upload steps can benefit more from Fusion due to removing the data exchange latency between in-series functions. On the other hand, functions that experience latency skew in the process step can benefit more from Bundling due to resource sharing.

The modeler also estimates the degree of correlation between latencies of either in-parallel or in-series functions, which is important for correctly estimate the impact of performing Fusion or Bundling. The output of the modeler is a performance model for each stage in the DAG that can estimate the latency distribution for each of the three steps (download, process, and upload) given a candidate computer resource allocation and bundle size. The DAG optimizer uses the generated performance models and explores the vast search space of Fusion, Bundling, and VM size allocations for the entire DAG. Next, it proposes the best set of transformations that leads to a new DAG which is given to the user for approval before deployment.

Deployment. In a typical deployment, a FaaS infrastructure deploys the system and applies it to serverless DAGs submitted by the clients. The FaaS infrastructure does the profiling runs needed for the performance modeler, without charging the client. In its profiling runs, the vendor cannot use content characteristics to enhance its model, due to data privacy limitations. It can however use metadata like the size of the input. However, the system may be executed external to the FaaS infrastructure and communicate with the FaaS API(s) of the cloud provider for implementing DaG's optimized by the system.

The FaaS infrastructure may be include services for developing, running, and managing application functionalities under the FaaS model. In the FaaS model, customers execute code in the cloud, while a cloud service provider hosts and manages the back-end operation. Customers are responsible only for their own data and the functions they perform. The FaaS model may be considered “serverless” from because the cloud service provider manages the cloud infrastructure, platform, operating system, and software applications-all of which may be opaque to the user.

“Serverless computing” is something of a misnomer, however. Even though FaaS users do not manage or even see the hardware, the FaaS model does run on servers. The hardware is owned, operated, and managed by the CSP, so customers can take full advantage of the functionality on demand, without purchasing or maintaining their own servers. Thus, the amount of computer resources provided to the allocated to functions executing on the FaaS infrastructure structure may be controlled or influenced through an application programming interface or other backend interface which allows for the development, deployment, and management of functions are executable in the FaaS infrastructure. The term computer resource, as described herein, refers to VM memory size, VM CPU core count, VM network bandwidth, VM storage size, or any other memory, processing, or networking resource made configurable for allocating to a VM by a FaaS infrastructure.

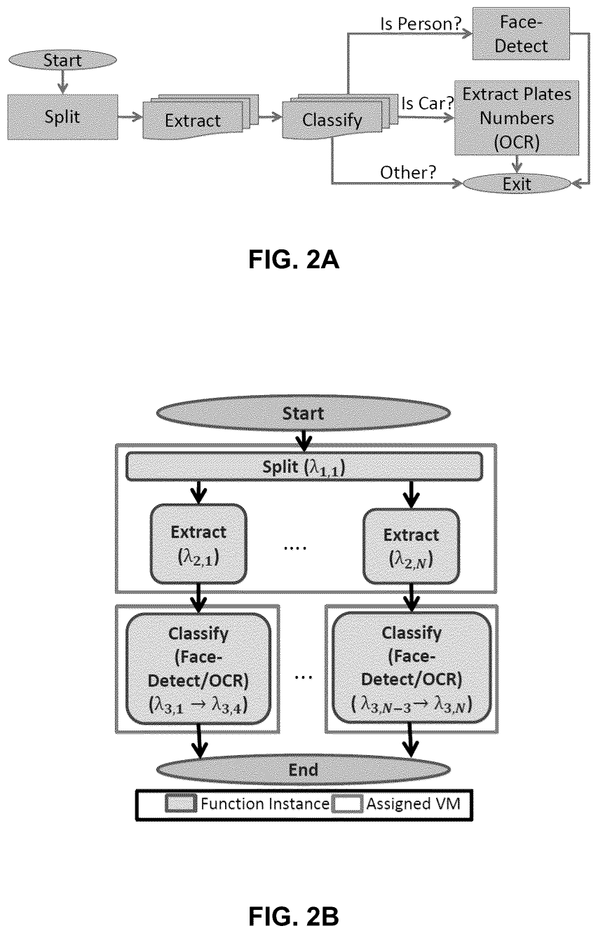

FIG. 2 illustrates examples of a user-defined DAG and an execution plan. The DAG from a video analytics application used for various experimentation and validation. The execution plan was selected by the DAG optimizer and includes a variation of the user-defined DAG with vertically fuse stages and horizontally bundled functions along with VMs assigned to each stage. The execution plan shown in FIG. 2B is illustrated in conceptual formal. The execution plan in data format may include associations between function identifiers, stage identifiers, bundle identifiers, virtual machine configuration, including virtual machine sizing information. For example, the execution plan may include a DAG along with information which specifies how functions in each stage are bundled and the virtual machine sizing for each bundle.

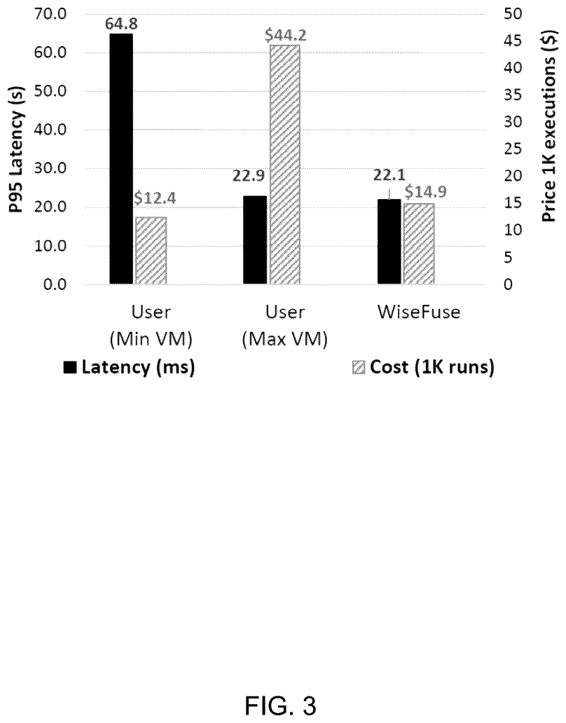

FIG. 3A-B illustrates an example of a serverless DAG of a video analytics application and an execution plan generated by the system. To get a sense of the impact of the contributions of the system and methods described herein, consider the impact of the execution plan shown in FIG. 2. Compared to the user-defined DAG (without performing any Fusion or Bundling action), the system achieves 64% lower latency over allocating the Min VM size for each function, and achieves 66% lower cost over allocating the Max VM size for each function.

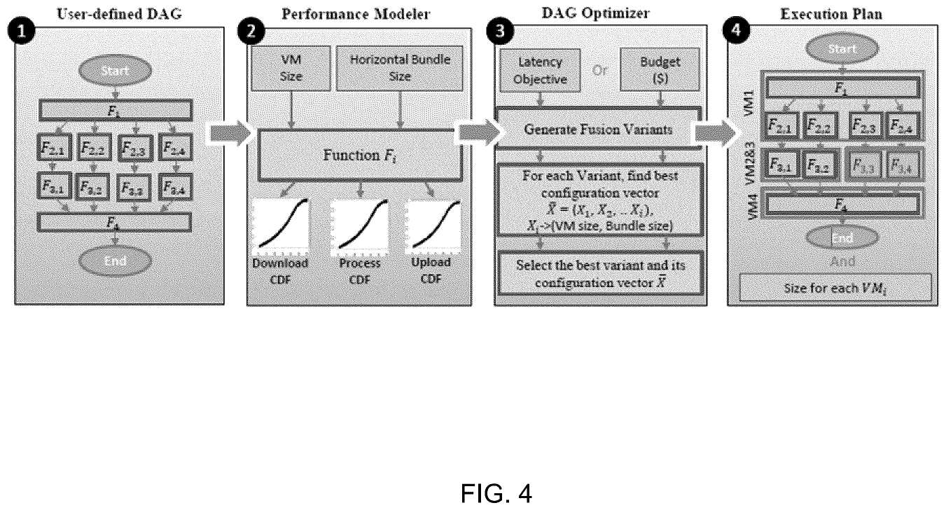

FIG. 4 illustrates a first example of a flow diagram for the system.

### Per-Function Performance Model

The system may receive a user-defined DAG. The first step is to build a performance model that maps the amount of resources for a given function to the expected latency distribution. Notice that modeling the latency distribution is important for both latency-sensitive and cost-sensitive applications. This is because of the pay-as-you-go cost model of serverless platforms, which bills the user proportionally to the product of the allocated resources and the function's runtime. We create this latency distribution separately for the three phases of a function's execution-data download, execution latency for the function itself, and data upload.

Profiling: To start off, the performance modeler profiles the latency distributions for various VM sizes (4 was found to be a good number in various experimentation), including Min and Max VM sizes. Min implies the lowest size at which the function will execute and Max implies the largest VM size supported by the FaaS platform. The value of the intermediate VM sizes vary for different FaaS platforms. For AWS Lambda, there are fine-grained VM sizes supported-128 MB to 10 GB in step sizes of 1 MB. We do not wish to profile for all possible VM sizes and we leverage discontinuities that exist in the vendor offerings. Hence, we pick 1,024 MB as one intermediate profiling point as that is the size at which AWS saturates the network bandwidth (i.e., increasing memory beyond it does not provide any more network bandwidth). We pick 1,792 MB as another intermediate profiling point as a VM with one full core gets assigned at that point. For GCP, there are only 7 VM sizes to pick from and here we can afford to profile for all sizes.

Interpolation: This initial profiling divides the configuration space into multiple regions. For example, for AWS Lambda, this divides the VM size space into 3 regions: Min-1024, 1024-1792, and 1792-Max. Afterward, the performance modeler performs percentile-wise linear interpolation to infer the CDF for the intermediate memory settings. For example, the P50 latency for 6 GB is estimated as the average between the P50 latency of 1.8 GB and of 10.2 GB. This generates a prior distribution for these intermediate memory settings. To verify the prediction accuracy in a region, the modeler collects a few test points using the midpoint memory setting in that region to measure its actual CDF (i.e., the posterior distribution) and compares it with the prior distribution. If the error between the prior and posterior CDFs is high (i.e., ≥15%) in any region, the modeler collects more data for the midpoint in that region and adds it to its profiled points, splitting that region further into two smaller regions. This process is repeated till saturation in accuracy is reached for all regions. In practice, we find that dividing the space into 5 regions is sufficient to achieve an error≤15% for all latency percentiles.

It should be appreciated that the per-function performance modeling can be applied to other types of computer resource allocations, such as number of cpu cores, network bandwidth, memory, or any other configurable computer resource allocation made available by the FaaS provider. In some examples, VM size may be a pre-packaged configuration setting in which multiple computer resource allocations are implied by one setting made available through the FaaS configuration interface.

### Estimating the Impact of Fusion

Here we show how performance modeler estimates the impact of fusing two in-series functions together. We represent the latency of a function as a composition of three components: (1) Download-duration (Down): the time to read the input file(s) from remote storage. (2) Process-duration (Proc): the computation time. (3) Upload-duration (Up): the time to upload the output file(s) to remote storage. Performance modeler models the function's latency PDF as a convolution between the three components:

$$P ( latency = t ) = P ( Down = k , Proc = m , Up = t - k - m ) \qquad ( 1 )$$

Notice that we still represent each component as the distribution of a random variable, rather than a constant, to capture the latency variability. By factorizing the latency into these three components, the performance modeler can easily estimate the impact of fusing two functions on their combined latency and cost. For example, if the performance modeler performs Fusion between Extract and Classify stages in shown in FIG. 2A, the performance modeler can remove the upload step from Extract and the download step from Classify. Thus, we estimate the combined latency as a convolution between Down (Extract), Proc (Extract), Proc (Classify), and Up (Classify) CDFs.

Importantly, the performance modeler takes into consideration the correlation between the different components to efficiently estimate the convolution between them. For example, the performance modeler estimates the Pearson correlation coefficient between all four components and find a strong correlation of 0.73 between Proc (Classify) and Up (Classify) CDFs. This is because it takes longer to perform object detection for frames with many objects; it also takes longer to crop and upload the detected objects. Hence the performance modeler uses the marginal distributions for the statistically independent components, while we use the joint distribution for highly correlated components (Proc (Classify) and Up (Classify) in this case).

### Estimating the Impact of Bundling

Here we show how the performance model estimates the impact of bundling parallel invocations together on their combined latency distribution.

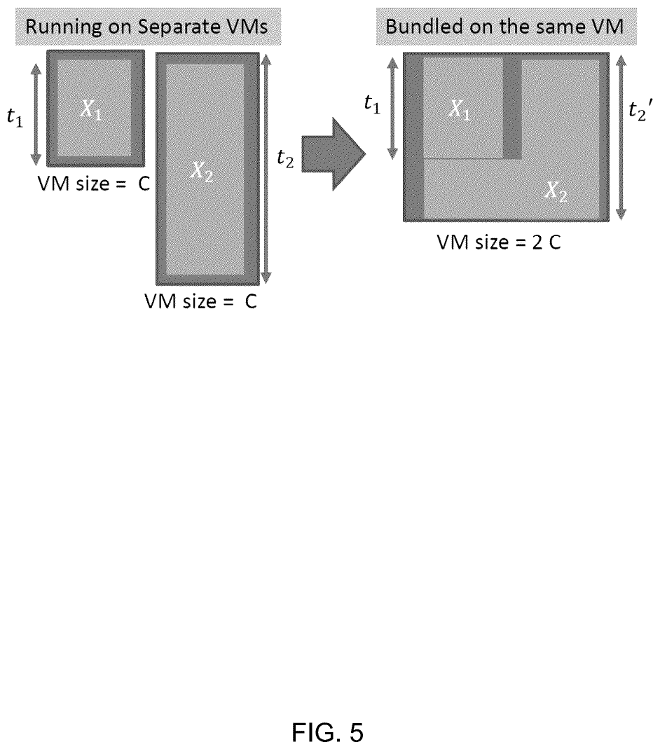

FIG. 5 illustrates an example of functions from a DAG executing on virtual machines with and without bundling. Without Bundling, latency is dominated by the straggler function (X2) and is equal to t2. With Bundling, function X2 gets more resources after X1 executes, decreasing the stage's latency to t2′.

By bundling parallel invocations, stragglers can leverage additional resources released by the fast executing workers. This allows for local resource sharing between the bundled workers and decreases their combined latency. Therefore, Bundling is beneficial and used when: (1) Functions are scalable: The function can leverage additional resources when made available. (2) Input content skew: Stragglers experience longer execution times due to their input content, not variability due to infrastructure (e.g., poor network bandwidth). (3) Stragglers can be spread out over different bundles, which we achieve through shuffling. For simplicity of design, we consider that workers can be bundled in powers of two only. Further, all bundle sizes within one stage are equal. Table 1 shows an example of pseudocode for estimating the latency distribution of a bundle of workers.

TABLE 1
Bundling Pseudocode

Input: NumIterations=N, PerfModel: Model, WorkerSize: C
Output: Latency CDF for bundled pair: CDF_{bundle}

| | |
|---|---|
| 1: | ## Use performance model to get the CDF for a single worker in the bundle with VM of size C |
| 2: | CDF_{single} = Model(C) |
| 3: | ## Use performance model to get speedup distribution for a single worker when executed on a VM of size 2C |
| 4: | CDF_{Double} = Model(2C) |
| 5: | ## divide the percentiles of the CDF with double sized VM over the CDF with single sized VM |
| 6: | CDF_{Speedup} = CDF_{Double}/CDF_{single} |
| 7: | for i = 0− > N do |
| 8: | ## Sample 2 latency points t1, t2 that where observed in the same run (to sustain the correlation) |
| 9: | Sort the points t1<t2 |
| 10: | Estimate skew = t2−t1 |
| 11: | Set reduced-skew = CDF_{Speedup}(skew) * skew |
| 12: | Add (t1 + reduced-skew ) to CDF_{bundle} |
| 13: | end for |
| 14: | return CDF_{bundle} |

First, DAG optimizer uses the performance model to estimate the latency distribution for a single function when assigned additional resources. For example, if the function is originally allocated a VM size (C) and then is bundled with another function in a VM with double the size (2C). The ratio between CDF (2C)/CDF (C) shows the speedup due to additional resources, i.e., the function's scalability. DAG optimizer then draws pairs of latency points from the profiles to capture the natural skew observed between the two workers. Then, DAG optimizer estimates the reduction of that skew (due to Bundling) using the speedup CDF. In summary, the algorithm considers two important factors: (1) The speedup distribution due to additional resources (2) The natural degree of skew observed between the two workers.

Notice that we represent the speedup as a distribution rather than a scalar value, which is essential to capture the reduction in latency for each latency percentile. In various experimentation, it was noticed the speedup varies for different percentiles. For example, the speedup on the median is only 11%, whereas it becomes 47% for the P95. This is because invocations at higher percentiles experience higher skew and therefore reap greater benefit from additional resources. A stage's latency is estimated as the “Max” latency among all bundles (stage i with N bundles):

$$P ( {X}_{i} \leq z ) = P ( {X}_{i , 1} \leq z , {X}_{i , 2} \leq z … {X}_{i , N} \leq z ) \qquad ( 2 )$$

Similar to Eq 1, identifying the correlation between the parallel workers is essential to accurately estimate the stage's latency distribution. Specifically, in case of a low correlation between parallel workers, we can simplify Eq 2 as the multiplication of the marginal distributions, P (Xᵢ≤z)=P (X_{i,1}≤z)^{N}. However, in case of a high correlation, this simplification can cause overestimation of the combined latency. In our applications, we observe a high enough correlation coefficient (0.4-0.6) between parallel workers, hence the performance model uses the joint distributions when estimating Eq 2.

### Execution Plan Optimization

Here we show the steps for finding an optimized execution plan for a user-given latency objective. Search Space: The size of DAG transformations, including Fusion, Bundling, and VM size selection may be calculated. Let D be a DAG of N stages, denoted as S₁, S₂, . . . , S_{N}. Since the DAG optimizer can perform Fusion of any consecutive pair of stages Sᵢ and Sᵢ₊₁, we have N−1 consecutive pairs, and for each pair, we have a binary decision (to fuse or not to fuse). By performing this decision recursively, we actually explore all possible Fusion configurations between consecutive stages (not just pairwise Fusion). Hence, we have a total of 2(N−1) possible combinations of Fusion actions. Since in practice N is not large (P50 depth is 2 and P99 is 12), this exhaustive search of Fusion space is feasible. Now, let the maximum degree of parallelism in any stage be 1K (recall that the actual observed P99 width is 84). Since we consider bundle sizes to be powers of 2 only, we have a maximum of log 2 (1000)≈10 possible bundle sizes for each stage. Notice that after the DAG optimizer performs Fusion for any pair of stages, they are represented as a single stage in the new DAG. Therefore, the total number of Fusion and Bundling actions is given by:

$${\sum }_{i = 1}^{N} \frac{N - 1}{i - 1} \times {10}^{i} \qquad ( 3 )$$

where i represent number of stages after performing any combination of Fusion actions, and it varies between 1 (all stages are fused into one stage), and N (no Fusion). For a DAG of 8 stages and max degree of parallelism of 1K, we have 215.6M possible Fusion and Bundling actions that we can select from. Notice that this space does not include the possible actions of selecting the VM sizes, which can be as few as 7 different sizes for Google Cloud, or as many as any memory size (in steps of 1 MB) between 128 MB and 10.24 GB for AWS Lambda. Thus, an exhaustive search to find the best plan is expensive and impractical.

Importance of E2E Optimization: Here we show the importance of selecting Fusion, Bundling, and VM allocation options for all stages in the DAG jointly, rather than optimizing each stage separately. Consider a DAG of 2 stages such that the first stage has only one function denoted as X₁. The second stage has k parallel invocations of a function, denoted as (X_{2,1}, X_{2,2}, . . . . X_{2,k}) and they receive their input files from X₁. Now, in order to achieve data locality between the two stages and minimize X₁'s latency, we perform Fusion. This forces execution of the sending function and all receiving functions in the same VM. Thus, Bundling occurs with a bundle size of k over the second stage. This can be harmful for large values of k where Bundling can cause contention in the VM and increase the E2E latency and cost.

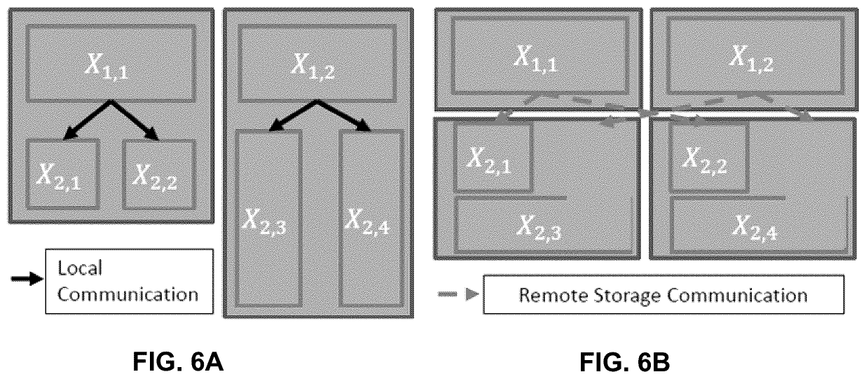

Another cause of local optimization shortcoming is that Fusion removes the possibility to “shuffle” stragglers across bundles, which is needed in many cases to break the locality of stragglers. FIG. 6A-B illustrates a DAG with fusion where shuffling is not possible and building without fusion where shuffling is possible. Consider the example shown in FIG. 6A for a stage of two workers X_{1,1} and X_{1,2} and each of the them triggers two workers in the second stage. In the second stage, workers X_{2,3} and X_{2,4} are stragglers. If we perform Fusion between the two stages (which is the best local decision for workers X_{1,1} and X_{1,2}), we will have to execute the two stragglers together in the same bundle and hence the locality of stragglers will remain. In contrast, if we do not perform Fusion between the two stages, we can spread the two stragglers over two separate bundles, which leads to a lower E2E latency for the bundles (FIG. 6B). Accordingly, selecting the best Fusion and Bundling actions for each stage separately (i.e., local optimization) is sub-optimal. The DAG optimizer avoids this pitfall by selecting the execution plan (which includes Fusion and Bundling options for all stages) that optimizes the E2E latency (or cost) for the entire DAG.

Search Strategy: Referring back to FIG. 4, the DAG optimizer takes as input either a latency objective (for latency-sensitive applications) and/or a budget (for cost-sensitive ones). The first step is to generate different Fusion variants from the user-defined DAG, and by default, we explore all Fusion variants. However, if exploring all Fusion variants is infeasible in a specific situation, the DAG optimizer may select a subset that fuses stages with high data exchange (upload/download) volume. Afterward, a searching algorithm is executed for each variant in parallel to identify its best configuration vector X̅, which denotes the best VM sizes and bundle sizes for each stage in that variant. After the configuration vectors are generated for all Fusion variants, we select the vector that meets the latency objective with the lowest cost. Equivalently, for the budget objective, the DAG optimizer selects the vector that meets the budget objective and provides the lowest latency among the options.

Handling Different Input Sizes: The same serverless DAG can be executed with different input sizes, which can impact the execution time, memory footprint, or the fanout degree of its functions. Accordingly, different input sizes can be optimally executed with different execution plans. The DAG optimizer leverages polynomial regression to estimate the upload, process, and download CDFs for new (unseen) input sizes. The order of the polynomial is different for different applications and stages. For example, upload and download CDFs of PCA stage in our ML pipeline application have a linear relation while its process CDF has a quadratic relation with input size (PCA has quadratic compute complexity).

Finding the best configuration vector: Table 2 shows pseudocode for the DAG optimizer.

TABLE 2
DAG Optimizer Pseudocode

Input: DAG = D with N stages, PerfModel = Model, Latency Target = T
Output: Execution Plan = ExecPlan

| | |
|---|---|
| 1: | ## From DAG D, get all m = 2^{(N-1)} Fusion variants DV₁, ... DVₘ |
| 2: | ## Initialize Set_{X̅} as empty set |
| 3: | for i = 0 to m (in-parallel) do |
| 4: | Set Vector X̅ = DP(DVᵢ, Latency Target T) |
| 5: | Add X̅ to Set_{X̅}[i] |
| 6: | Set Cost[i] = GetCost(DVᵢ, X̅, Model) |
| 7: | Set Latency[i] = GetLatency(DVᵢ, X̅, Model) |
| 8: | end for |
| 9: | ## Across all variants, find best variant index i_{best} |
| | such that Latency[i_{best}] ≤ T and Cost[i_{best}] is minimum |
| 10: | return ExecPlan = (DVᵢ_{_{best}}, Set_{X̅}[i_{best}]) |

First, the DAG optimizer access the performance modeler and estimates the latency distribution for the fused stages as previously discussed. Afterward, the DAG optimizer applies a Dynamic Programming (DP) search algorithm to select the best VM size and bundle size for each stage. We observe that our optimization problem can be reduced to the well known Knapsack problem. We set the knapsack's capacity to be our latency objective for the latency-sensitive application (equivalently, the capacity would be our $ cost objective for a cost-sensitive application). The items in the knapsack represent configurations of each stage (one configuration/stage). The weight of each item is the latency of that configuration and the cost of each item is the inverse of the $ cost of that configuration (since our target is to minimize the cost subject to meeting the latency objective). The algorithm proceeds as follows: For each stage in the DAG, we estimate the latency and cost for each feasible action, which includes all VM sizes (in steps of 128 MB) and all bundle sizes (in powers of 2). Divide the latency objective into equal-sized windows (10 ms) and actions that lead to the same latency window are considered equivalent. Hence only the action that has the least cost is saved in the DP table, while others are pruned. By doing so, we keep the number of solutions that gets transferred from one stage to the next bounded (at most A×T), leading to a much faster searching time. Specifically, the time complexity is O(S×A×T), where S is the number of stages, A is the number of possible actions per stage, and T is the number of latency buckets (Latency Target/10 ms). For a DAG of 8 stages, 46 VM sizes, and 10 bundle sizes for each stage, we have 3.68K actions to explore using DP, compared to 215.6M for the exhaustive case.

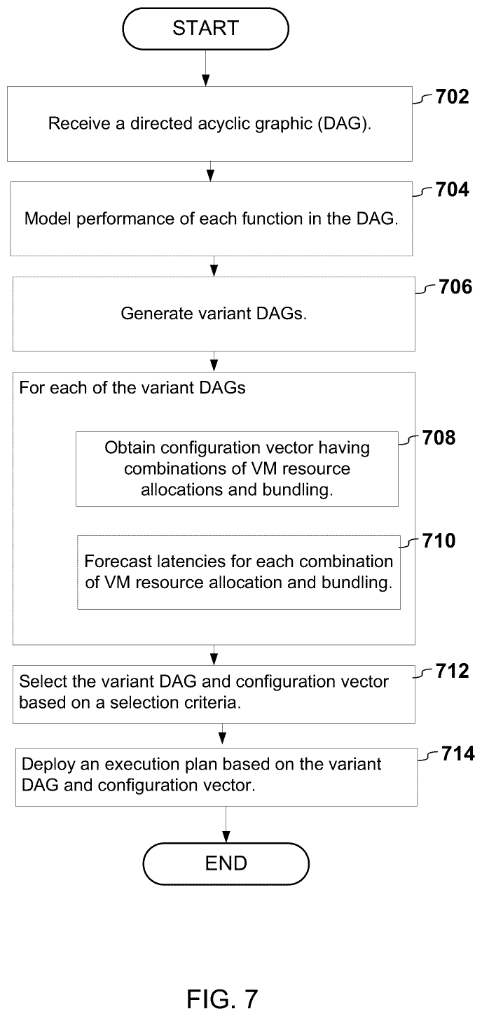

FIG. 7 illustrates an example a flow diagram for logic for the system. The system may receive a DAG (702). The system may model performance of each function of the DAG to generate a performance model (704). The performance model will receive a configuration vector having a VM sizing information, bundling information.

The DAG optimizer may generate variant DAGs (706). Functions in the variant DAGS may be fused together such that functions from the input DAG in two consecutive stages are combined together.

For each of the variant DAGs, the DAG optimizer 104 my obtain a configuration vector (708). The configuration vector may include combinations of bundle size and computer resource allocations. The DAG optimizer may forecast latencies for each combination of bundle size and computer resource allocation (710). For example, the DAG optimizer may access the performance model to estimate an end-to-end (E2E) latency for the performance model using the VM size(s) and bundle size(s) in the configuration vector.

The DAG optimizer may select the variant DAG based on a selection criteria. The selection criteria may include the latency objective and/or the budget objective (712). The DAG optimizer may generate an execution plan which includes the variant DAG and the configuration parameters. Functions may be bundled together and VM sizing may be associated with each bundle and/or function.

Finally, the deployment services 106 may deploy the execution plan (714). For example, the deployment services 106 the variant DAG to a FaaS infrastructure. Virtual machines may be sized according to the sizing information in the configuration vector and functions within a stage are bundled together on a virtual machine according to the bundling information the configuration vector. Alternatively or in addition, the VM may be allocated memory, CPU cores, network band width, and/or storage capacity based on the computer resource allocation specified in the configuration vector.

The logic illustrated in the flow diagrams may include additional, different, or fewer operations than illustrated. The operations illustrated may be performed in an order different than illustrated.

The system 100 may be implemented with additional, different, or fewer components than illustrated. Each component may include additional, different, or fewer components.

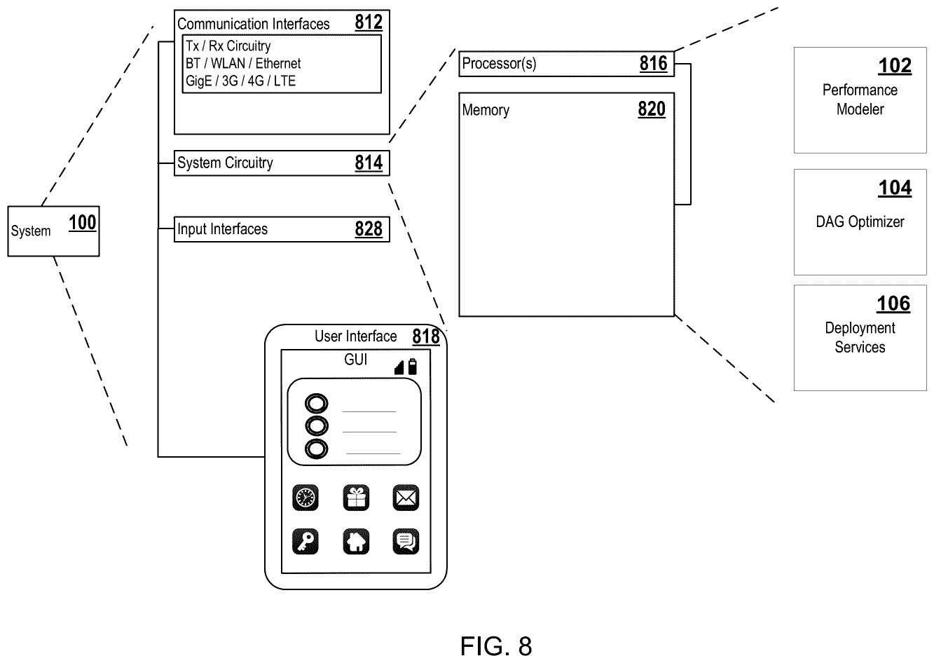

FIG. 8 illustrates a second example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations the performance modeler 102, the DAG optimizer 104, the deployment services 106, the FaaS infrastructure, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the performance modeler 102, the DAG optimizer 104, the deployment services 106, and/or the system 100. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the performance modeler 102, the DAG optimizer 104, the deployment services 106, or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method, comprising:
receiving a first directed acyclic graphic (DAG) for an application, the DAG comprising a plurality of stages arranged in a series, each stage comprising at least one function;
modeling performance of each function in the DAG to generate a performance model;
generate a plurality of variant DAGs, wherein functions in the variant DAGs from at least two consecutive stages in the first DAG are vertically combined;
for each of the variant DAGs,
obtaining a configuration vector, comprising a plurality of combinations of bundle size and computer resource allocations; and
forecasting, based on the performance model and the configuration vector, a plurality of end-to-end latency distributions for the variant DAGS;
selecting the variant DAG and configuration vector based on a selection criteria; and
causing an application to be executed according to the variant DAG and configuration vector.

2. The method of claim 1 where modeling performance of each function in the DAG comprises:
generating a performance model which estimates an end-to-end (E2E) latency based combining at least two functions from different stages in the DAG, a candidate computer resource allocation and a candidate bundle size.

3. The method of claim 1, wherein forecasting, based on the performance model and the configuration vector, a plurality of end-to-end latency distributions for the variant DAGS further comprises:
obtaining, using the performance model and a computer resource allocation, function latency distributions for the functions of a variant DAG;
generating latency distributions for each stage of the variant DAG.

4. The method of claim 3, wherein the function latency distributions each include a latency distribution for a download portion of a corresponding function, a latency distribution for a process portion of a corresponding function, and a latency distribution for an upload portion of a corresponding function.

5. The method of claim 1, generating a plurality of variant DAGs further comprises:
bundling functions from at least one stage of the first DAG and assigning them to a virtual machine.

6. The method of claim 1, wherein causing an application to be executed according to the variant DAG and configuration vector;
deploying the variant DAG to a FaaS infrastructure, wherein functions within a stage are bundled together on a virtual machine according the configuration vector.

7. The method of claim 6, wherein the virtual machine is allocated computer resources according to the configuration vector.

8. A system, comprising:
a processor, the processor configured to:
receive a first directed acyclic graphic (DAG) for an application, the DAG comprising a plurality of stages arranged in a series, each stage comprising at least one function;
model performance of each function in the DAG to generate a performance model;
generate a plurality of variant DAGs, wherein functions in the variant DAGs from at least two consecutive stages in the first DAG are vertically combined;
for each of the variant DAGs,
obtain a configuration vector, comprising a plurality of combinations of bundle size and computer resource allocations; and
forecast, based on the performance model and the configuration vector, a plurality of end-to-end latency distributions for the variant DAGS;
select the variant DAG and configuration vector based on a selection criteria; and
cause an application to be executed according to the variant DAG and configuration vector.

9. The system of claim 8, wherein to model performance of each function in the DAG, the processor is further configured to:
generate a performance model which estimates an end-to-end (E2E) latency based combining at least two functions from different stages in the DAG, a candidate computer resource allocation and a candidate bundle size.

10. The system of claim 8, wherein to forecast, based on the performance model and the configuration vector, a plurality of end-to-end latency distributions for the variant DAGs, the processor is further configured to:
obtain, using the performance model and a computer resource allocation, function latency distributions for the functions of a variant DAG;
generate latency distributions for each stage of the variant DAG.

11. The system of claim 10, wherein the function latency distributions each include a latency distribution for a download portion of a corresponding function, a latency distribution for a process portion of a corresponding function, and a latency distribution for an upload portion of a corresponding function.

12. The system of claim 8, wherein to generate a plurality of variant DAGs, the processor is further configured to:
bundle functions from at least one stage of the first DAG and assigning them to a virtual machine.

13. The system of claim 8, wherein to cause an application to be executed according to the variant DAG and configuration vector, the processor is further configured to:
deploy the variant DAG to a FaaS infrastructure, wherein functions within a stage are bundled together on a virtual machine according the configuration vector.

14. The system of claim 13, wherein the virtual machine is allocated computer resources according to the configuration vector.
